(19) United States
(12) Patent Application Publication
(10) Pub. No.: US 2007/0287392 A1
(43) Pub. Date: Dec. 13, 2007

(54) Mobility Handling

(76) Inventors: Jacques Sagne, Volvestre (FR); Peter Hans Edlund, Tumba (SE); Karl Olof Joakin Bergstrom, Stockholm (SE)

Correspondence Address: ERICSSON INC., 6300 LEGACY DRIVE, M/S EVR 1-C-11, PLANO, TX, 75024, US

(21) Appl. No.: 10/597,876

(22) PCT Filed: Dec. 22, 2004
(86) PCT No.: PCT/SE04/01977

§ 371 Date: May 22, 2007

(30) Foreign Application Priority Data
Feb. 11, 2004 (SE) 0400339-8

(51) Int. Cl. H04B 1/04

(52) U.S. Cl. 455/119

(57) ABSTRACT

The invention relates to an improved mobility handling within a radio access network (3) of an MBMS-joined mobile terminal (7) in a state in which the location of the mobile terminal is stored only at cell group (e.g. URA) level, e.g. a URA_PCH state. A context information transfer is performed at certain trigger events via the Iur-interface (8a, 8b) between a serving radio network controller (SRNC) and all potential drift radio network controllers (DRNCs) for the mobile terminal.

### TECHNICAL FIELD OF THE INVENTION

The present invention relates to the mobility handling of mobile terminals subscribing to a multimedia service, such as e.g. the MBMS (Multimedia Broadcast/Multicast Service) of the 3GPP (Third Generation Partnership Project).

### BACKGROUND OF THE INVENTION

Third generation telecommunication systems offer higher and variable bit-rates and are capable of providing new types of services to the users. The MBMS included in the 3GPP-standard provides broadcasting/multicasting of various multimedia information to users, and information providers are able to transmit multimedia information, such as e.g. news, sport results and weather forecasts, to several joined MBMS service subscribers simultaneously.

The relationship between a service provider of the MBMS and a user is established as an MBMS subscription, allowing the user to receive the related MBMS information. When a user wishes to receive the MBMS information, he activates the MBMS by joining a multicast group, thereby indicating to the network that he is prepared to receive multimedia information from a specific MBMS. The MBMS service provider will start to send data at an MBMS session start, and a session start will occur independently of the users MBMS activation. The session will start by an MBMS notification, which informs the joined mobile terminals that MBMS information will be transmitted to the multicast group. When the user no longer wishes to receive any MBMS information, he deactivates the MBMS and resigns from the multicast group.

Multimedia information may be transmitted in the broadcasting mode or in the multicasting mode. In the broadcasting mode, only the point-to-multipoint (PTM) transmission scheme is used, in which the same media stream is broadcasted to many user simultaneously, without taking into account whether any terminals receive it or not. In the multicast mode, two different transmission schemes may be used, either the point-to-point (PTP) scheme, in which data is delivered to each user individually, using a dedicated traffic channel, or the PTM scheme, in which the same media stream is broadcasted on a common channel, which is received by several terminals. The PTM mode is preferred when the number of users (in a cell) wishing to receive the same multimedia information is large, and the PTP mode is advantageous when only a few users (in a cell) are interested in the same multimedia information. Therefore, the available radio resources will be optimally used if a choice between the PTM scheme and the PTP scheme is based on the result of counting the number of users within a cell.

The 3GPP-standard relates to technology based on radio access networks such as UTRAN (the Universal Mobile Telecommunications (UMTS) Terrestrial Radio Access Network), which is a radio access network architecture providing W-CDMA (Wideband Coding Division Multiple Access) to mobile terminals.

A mobile terminal, e.g. a mobile phone provided with a SIM (Subscriber Indentity Module)-card, can communicate with a core network connected to external networks, e.g. the Internet and the PSTN (the Public Switched Telephone Network), via a UTRAN covering a geographical area divided into cells with unique identities. Each cell is served by a base station, and within the UTRAN a number of adjacent cells form a cell group defined as a UTRAN Registration Area (URA). One cell may belong to more than one URA, and the radio coverage of a cell is provided by the radio base station equipment (i.e. antennas) located at the serving base station site.

In the 3GPP specification, the base stations, called Node Bs, communicate with mobile terminals within coverage via an air interface, called Uu-interface. One Node B is serving one or more cells, and the Node Bs are supervised by RNCs (Radio Network Controllers), which are managing important resources of the UTRAN and are connected to one or more core networks. The Node Bs are communicating with the RNCs via an Iub-interface, the RNCs are communicating with the core networks via an Iu-interface, and the communication between RNCs is performed via an Iur-interface. The UTRAN interfaces (Iu, Iub and Iur) have one control plane and one user plane, and the RNSAP (Radio Network Sub-system Application Part) is a control plane protocol for the Iur interface

Since mobile terminals may move between different cells within a radio network, mobility handling is an important issue in any cellular telecommunication system. In a UTRAN, the radio network controllers (RNCs) are adapted to handle the mobility of the mobile terminals, e.g. by means of the different roles of the RNCs in relation to each mobile terminal. An RNC will function as either a Serving RNC (SRNC) or a Drift RNC (DRNC), with respect to a certain mobile terminal, until the mobile terminal is disconnected from the UTRAN, e.g. at power off. The SRNC of a certain mobile terminal will store a context for the mobile terminal, the context comprising information regarding the connection of the mobile terminal between the core network and the radio network via the Iu interface. An RNC functioning as an SRNC for a mobile terminal will control the connection of the mobile terminal within the radio access network, while the DRNC is any other RNC that controls a cell used by the mobile terminal. A specific mobile terminal will always have only one SRNC, and a RNC functioning as an SRNC for one mobile terminal may simultaneously function as a DRNC for other mobile terminals. An RNC will also function as a Controlling RNC (CRNC) for the Node Bs connected to it via the Iub interface, and the CRNC will control the radio resources for the cells served by the connected Node Bs. Thus, a physical RNC will normally contain all SRNC, DRNC and CRNC functionalities. Regarding the radio resource control (RRC), the mobile terminal operates either in an Idle Mode or in a Connection Mode, and the mobile terminal automatically enters the Idle Mode at power on, before a connection is established between the mobile terminal and a UTRAN. When a connection is established, the mobile terminal enters the Connected Mode, and is assigned a U-RNTI (a UTRAN Radio Network Temporary Identity), which can be used in any cell of UTRAN. Within the Connected Mode there are four different states, i.e. the CELL_DCH (Dedicated Channel) state, the CELL_FACH (Forward Access Channel) state, the CELL_PCH (Paging Channel) state and the URA_PCH state. In the CELL_DCH state, a dedicated traffic channel is allocated to the mobile terminal, in the CELL_FACH state the mobile terminal monitors a common channel (the FACH) continuously in the downlink of the selected cell and uses a RACH (Random Access Channel) as uplink, and in the CELL_PCH state the mobile terminal monitors a paging channel of a selected cell. In these three states the mobile terminal will update the SRNC at cell relocation with its new cell location by sending a cell updating message.

However, in the fourth state, the URA_PCH state, is a cell group location, i.e. the URA location, instead of the cell location, stored in the mobile terminal context information in the SRNC, and the mobile terminal will not send any cell updating message at cell relocation. Instead, it will update the SRNC with its new URA location only when crossing a URA border by sending a URA updating message to the SRNC. If the mobile terminal moves between cells while in the URA_PCH state, the relocation of a mobile terminal will be unknown to the SRNC if the new cell belongs to the same URA as the original cell. Since a URA may span over cells served by Node Bs connected to different RNCs, a specific mobile terminal may also relocate to a cell connected to a different RNC than its SRNC without sending any updating message to the SRNC. The RNC connected to the new cell will function as a DRNC with respect to this specific mobile terminal. Since an RNC functioning as a DRNC for a mobile terminal will have no stored mobile terminal context information, according to the state of the art, e.g. regarding a joined MBMS service, this may result in that the mobile terminal will not receive the MBMS service.

Thus, the mobility handling of a mobile terminal in the URA_PCH state in a UTRAN will cause problems relating to MBMS services, e.g. for an MBMS-joined mobile terminal in the URA_PCH state to be able to receive an MBMS notification at session start and for the URA_PCH mobile terminals to be counted for a PTM/PTP decision.

When a mobile terminal subscribing to an MBMS service has joined an MBMS multicast group, mobile terminal context information regarding the subscription will only be stored in the SRNC. When the mobile terminal is located in a URA only containing cells served by Node Bs connected to the SRNC and the cells also belong to the multicast area of the MBMS service, the mobile terminal will always receive an MBMS notification from the SRNC at the start of the MBMS session. However, when the URA in which this specific mobile terminal is located also contains cells served by Node Bs connected to a different RNC, the mobile terminal may move to any of those cells without sending any updating message to its SRNC. Since the new RNC will function as a DRNC with respect to this specific mobile terminal, and not as an SRNC, no context information regarding the mobile terminal is stored therein, and the DRNC will not send any MBMS notification to this mobile terminal when an MBMS session starts. (Unless the new RNC broadcasts an MBMS notification of the session start to other mobile terminals located in cells served by a Node B supervised by the RNC in its role as CRNC, and the specific mobile terminal is located in one of those cells.)

Further, a counting procedure of all MBMS-joined mobile terminals located within the cells served by the connected Node Bs will normally be performed at session start. The result of the counting is used by the CRNCs to select the PTM scheme or the PTP scheme for the transmission of an MBMS session start notification and of MBMS data to the cells. The counting of MBMS-joined mobile terminals in a connected mode in a specific cell is normally performed by counting the mobile terminals indicating the specific cell location as well as the joined MBMS information, and the idle mode mobile terminals counting is solved by a certain fraction requesting RRC connection and transiting to the connected mode. However, since the context information of a mobile terminal in the URA_PCH state does not indicate the cell location, but only the URA location, a mobile terminal in the URA_PCH state will not be counted, according to the state of the art.

Therefore, the object of the present invention is to solve the problems described above relating to the mobility handling of a multimedia service joined mobile terminal in a state in which the exact cell location is unknown, e.g. in a URA_PCH state, especially in the 3GPP.

### DESCRIPTION OF THE INVENTION

It is an object of the present invention to provide a solution for an improved mobility handling of a multimedia service joined mobile terminal when the mobile terminal is in a state in which the cell location of the mobile terminal is unknown, e.g. in a URA_PCH state.

A further object of the invention is to provide a multimedia session start notification to a joined mobile terminal in said state, and to provide a counting procedure for said mobile terminal, located in a specific cell.

More specifically, the object of the invention is to provide an improved mobility handling in 3GPP of an MBMS-joined mobile terminal in the URA_PCH state.

These objects and others are achieved by the method and the radio network controllers according to the attached claims, which are hereby incorporated in their entirety. The independent method claim is directed to an information transfer between a transmitting serving radio network controller and receiving potential drift radio network controllers. The radio network controller claims are directed to one independent claim for a serving radio network controller node and one independent claim for a potential drift radio network controller node.

More specifically, the claims are related to a method of handling the mobility of a multimedia service joined mobile terminal in a radio access network when the mobile terminal is in a cell group location state, in which state the location of the mobile terminal is stored only at cell group level, not at cell level. The location at cell group level is stored in a context of a radio network controller functioning as a serving radio network controller for the mobile terminal. An information transfer is performed at a first trigger event via an Iur-interface between said serving radio network controller (SRNC) and all radio network controllers controlling at least one cell in a first cell group and being potential drift radio network controllers (DRNCs) for the mobile terminal. The information transfer comprises the steps of the SRNC sending a multimedia service attach requesting message to said potential DRNCs, said multimedia service attach requesting message comprising context information for said mobile terminal. The context information includes multimedia service information, and the potential DRNCs creates and stores a context for said mobile terminal based on the received message.

This information transfer via the Iur interface enables the potential DRNCs to send an MBMS notification to the mobile terminal at session start of an MBMS service, and the term potential DRNC is defined as all RNCs controlling at least one cell in the cell group (e.g. URA) in which said mobile terminal is located. This information transfer also enables the DRNC/CRNC to count a mobile terminal in the URA_PCH state when the mobile terminal is relocated to a cell served by a Node B connected to the DRNC/CRNC, wherein the result of the counting determines the choice of a PTP or a PTM transmission scheme to a cell.

The transferred context information may comprise the identity of the joined multimedia service, the identity of the cell group, the temporary identity of the mobile terminal within the network, and the identity of the mobile terminal.

The SRNC and the potential DRNCs may send a multimedia session start notification based on the transferred context information when a multimedia session start notification is received from a core network.

The trigger event may be the SRNC receiving a cell group updating message from the mobile terminal, and a multimedia service detach requesting message may be sent from the SRNC to all potential DRNCs in the previous cell group if the new cell group comprises only cells controlled by new RNCs, the potential DRNCs in the previous cell group deleting the stored context of the mobile terminal.

The trigger event may also be the mobile terminal transiting into said cell group location state from any other state, or the SRNC receiving a notification from the core network of a start of a multimedia service session.

Each of the potential DRNCs may create and store a multimedia service context in case no other multimedia service joined mobile terminal is located in a cell controlled by said potential DRNCs, and the multimedia service context may comprise the identity of the multimedia service and the temporary identity of the mobile terminal within the radio access network. Further, a counting procedure may be performed for each cell before a PTM/PTP decision by radio network controllers functioning as Controlling Radio Network Controllers (CRNCs). The counting procedure may be performed by paging each mobile terminal in the cell group location state individually by means of the stored context information, or by including a cell group location specific paging information comprising a probability factor in a broadcasted multimedia service session start notification, or by estimating a probability factor for the mobile terminals of each cell.

The claims also relate to a radio network controller in a radio access network, the radio network controller functioning as a serving radio network controller (SRNC) for a multimedia service joined mobile terminal in a cell group location state. The SRNC is provided with stored context information for said mobile terminal, and is arranged to communicate with other radio network controllers via an Iur interface. The SRNC is further provided with means for performing an information transfer of a multimedia service attach requesting message comprising said context information at a trigger event to all other radio network controller controlling at least one cell within the cell group of the mobile terminal, said other radio network controllers being potential drift radio network controllers (DRNCs) for said mobile terminal.

The context information may comprise the identity of the joined multimedia service, the identity of the cell group, the temporary identity of the mobile terminal within the network, and the identity of the mobile terminal.

The radio network controller may be provided with means for sending a multimedia session detach requesting message to all potential DRNCs in the previous cell group upon receiving a cell group updating message from the mobile terminal and the new cell group only consist of cells controlled by new RNCs.

The claims also relate to a radio network controller being a potential drift radio network controller (DRNCS) for a multimedia service joined mobile terminal in a cell group location state. The radio network controller is arranged to communicate with other radio network controllers via an Iur interface, and is provided with means for receiving an information transfer of a multimedia service attach requesting message comprising context information for the mobile terminal from a radio network controller functioning as a serving radio network controller (SRNC), according to this invention, for said mobile terminal, and further provided with means for creating and storing context information for the mobile terminal using the received message.

The context information may comprise the identity of the joined multimedia service, the identity of the cell group, the temporary identity of the mobile terminal within the network, and the identity of the mobile terminal.

The radio network controller may be provided with means for sending a multimedia service session start notification to said mobile terminal based on said stored context information when a multimedia session start notification is received from a core network, and further by means for creating and storing a multimedia service context in case no other multimedia service joined mobile terminal is located in the cells controlled by the radio network controller, the multimedia service context comprising the identity of the multimedia service and the temporary identity of the mobile terminal within the radio network.

The claims also relate to a radio network controller according to the invention, further provided with means for functioning as a Controlling radio network controller (CRNC), and comprising means for performing a counting procedure before making a PTP/PTM decision for a cell.

The means for performing said counting procedure may comprise means for paging each mobile terminal in the cell group location state individually by means of the stored context information, or for including a cell group location specific paging information comprising a probability factor in a broadcasted multimedia service session start notification, or for estimating a probability factor for the mobile terminals of each cell.

Said first cell group may consist of a UTRAN Registration Area (URA), the cell group location state may be a URA_PCH state, the multimedia service may be a Multimedia Broadcasting/Multicasting Service (MBMS), and said multimedia service attach requesting message may be an MBMS ATTACH REQUEST, according to the 3GPP standard.

Other features and further advantages of the invention will be apparent from the following description and figures, as well as from the attached claims.

### BRIEF DESCRIPTION OF THE DRAWINGS

The present invention will now be described in more detail and with reference to the embodiments and to the drawings, of which:

FIG. 1 illustrates schematically a third generation mobile communication system,

FIG. 2 is a schematic block diagram illustrating e.g. the URAs of a UTRAN,

FIG. 3 is a flow chart of steps comprised in an embodiment of the Iur-linking procedure according to the invention,

FIG. 4 is a flow chart of the steps in an embodiment of an MBMS session comprising an Iur-linking procedure according to the invention, and

FIG. 5 is a flow chart of the steps performed when a mobile terminal in the URA_PCH state relocates to a new URA, according to an embodiment of the invention.

### DESCRIPTION OF PREFERRED EMBODIMENTS

The terms and expressions used in the description and in the claims are meant to have the meaning normally used by a person skilled in the art, and the following abbreviations will be used:

3GPP: Third Generation Partnership Protocol

UTRAN: UMTS Radio Access Network

MBMS: Multimedia Broadcast/Multicast Service

RNC: Radio Network Controller

CRNC: Controlling RNC

SRNC: Serving RNC

DRNC: Drift RNC

RRC: Radio Resource Control

RAN: Radio Access Network

URA: UTRAN Registration Area

PTP: Point To Point

PTM: Point To Multipoint

IMSI: the International Mobile Station Identity

DRX: Discontinuous Reception Scheme

U-RNTI: the UTRAN Radio Network Temporary Identifier

MCCH: MBMS Control Channel

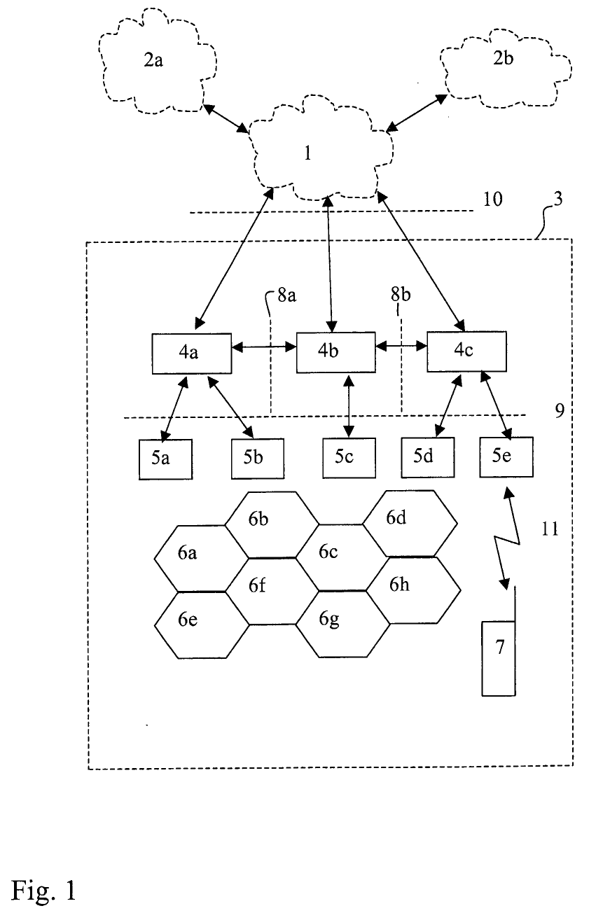

FIG. 1 illustrates a third generation mobile communication system, comprising a core network 1 and a UTRAN 3, in which the core network 1 provides connections to the external networks 2a and 2b, e.g. the Internet, a PSTN (Public Switched Telephone Network), or other mobile networks, and is also connected to the UTRAN 3 via an Iu-interface 10, said UTRAN comprising a number of RNCs 4a, 4b, 4c, which are interconnected by means of Iur-interfaces 8a and 8b. The RNCs each supervises a number of Node Bs 5a, 5b, 5c, 5d, 5e via an Iub interface 9, and each Node B handles the radio access within one or more cells 6a, 6b, 6c, 6d, 6e, 6f, 6g, 6h. A mobile terminal 7 may relocate between cells, and communicates via an air interface 11 (i.e. a Uu-interface), where radio coverage in each cell is provided by a specific Node B. As described above, an RNC functions either as a Serving RNC or a Drift RNC with respect of a specific mobile terminal, until e.g. power off of the mobile terminal or when the mobile terminal is converted to idle mode due to inactivity, also when the mobile terminal moves over a large geographical area and passes through several cells.

According to this invention, an improved mobility handling is achieved for a mobile terminal in the URA_PCH state in a UTRAN, thereby solving at least some of the problems of prior art relating to MBMS services, e.g. to provide a reliable notification to the MBMS-joined mobile terminals at session start of an MBMS service and to enable counting of the URA_PCH state mobile terminals within a cell for the PTP/PTM decision.

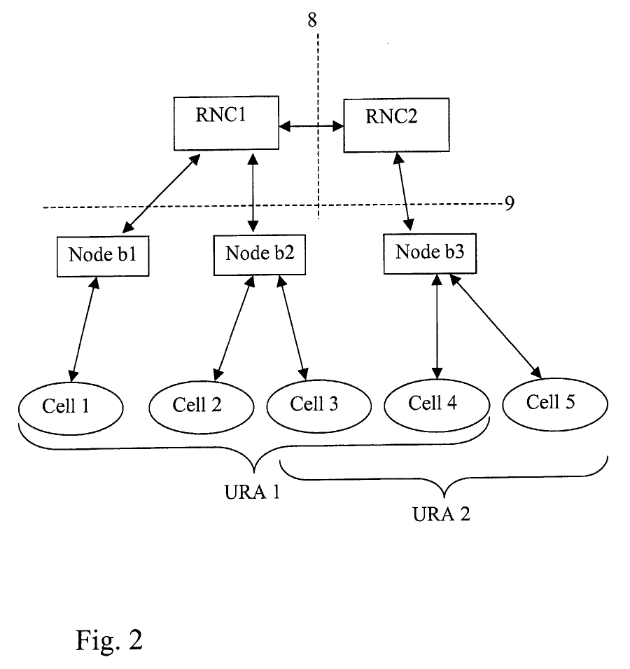

The problem associated with the prior art of providing a notification at session start to an MBMS-joined mobile terminal in the URA_PCH state, will now be described with reference to FIG. 2, showing two RNCs, RNC1 and RNC2 communicating with each other via an Iur-interface 8. Each RNC further communicates via an Iub-interface 9 with at least one Node B, and in this example RNC1 is connected to Node b1 and Node b2, and RNC2 is connected to Node b3. Node b1 serves Cell 1, Node b2 serves Cell 2 and Cell 3, and Node b3 serves Cell 4 and Cell 5. According to this illustrated example, the Cells 1-5 correspond to two different URAs, that partly span over the same cells; URA 1 spans over Cell 1, Cell 2, Cell 3 and Cell 4, while URA 2 spans over Cell 3, Cell 4 and Cell 5. Hence, Cell 3 and Cell 4 belong to both URA 1 and URA 2.

A first mobile terminal (not shown) located in Cell 2 has RNC1 as its SRNC, in which a mobile terminal context is stored, the mobile terminal context comprising information regarding a joined MBMS service of the mobile terminal. If a mobile terminal transits to the URA_PCH state while being located in URA1 and is assigned to belong to URA1, the mobile terminal will be able to relocate to any of the cells 1-4 without sending any URA updating message to its SRNC. Consequently, said first mobile terminal will not send any URA updating message to RNC1 if it relocates to Cell 4, even though the mobile terminal now is located in a cell served by Node b3, which is supervised by RNC2, and RNC2 has no stored context for the mobile terminal. If RNC1 now receives an MBMS notification from the core network of an MBMS session start, RNC1 will only broadcast this MBMS notification on the MCCH (MBMS Control Channel) to the cells served by Node b1 and Node b2, which are supervised by RNC1, i.e. to cells 1-3, and said first mobile terminal will not receive any MBMS notification of the MBMS session start. In case another MBMS-joined mobile terminal is also located in cell 4, but has RNC2 as is SRNC, the RNC2 will broadcast the notification as well, and the first mobile terminal will still be able to receive the notification. However, a mobile terminal in the URA_PCH state will miss an MBMS notification of an MBMS session start and fail to receive the MBMS service if no other MBMS-joined mobile terminal, having a context in RNC2, is located in the same cell.

In case the first mobile terminal relocates to Cell 5, it will send an URA updating message to its SRNC, i.e. RNC1, but according to prior art still no mobile terminal context will be stored in RNC2, since RNC2 is not functioning as an SRNC for the first mobile terminal, but only as a DRNC. However, RNC1 will update its mobile terminal context with the new URA location of the mobile terminal. When RNC1 receives an MBMS session start notification, it may notify a URA_PCH state mobile terminal in Cell 5 of the session start by means of dedicated paging, i.e. on DCCH. However, the dedicated paging according to prior art may cause overload and loss of the paging message, which will also result in a missed MBMS notification.

The problem in the prior art of counting the mobile terminals in the URA_PCH state in a cell in order to make a correct PTP/PTM decision, will now also be described with reference to FIG. 2. As in the previous example, if a mobile terminal in a URA_PCH state is relocated to Cell 4, the mobile terminal will not send any URA updating message, and no mobile terminal context is stored in RNC2. In case RNC2 still would receive an MBMS notification of session start due to other MBMS-joined mobile terminals, RNC2 will initiate a counting procedure in order to base its PTM/PTP decision on the number of joined mobile terminals in Cell 4. Connected mode mobile terminals, not in the URA_PCH state, will be counted by counting of the MBMS mobile terminal contexts stored for Cell 4, and the Idle mode mobile terminals will be counted with a counting procedure in which a certain fraction sends a RRC connection requesting message and transits to connected mode. If the number of counted mobile terminals is large enough, the PTM scheme will be selected for transmission. However, URA_PCH state mobile terminals will not be counted with any of these prior art procedures, since the RNC has no context for this mobile terminal, and the mobile terminal will not respond to the Idle mode counting. Therefore, there is a risk that an erroneous PTP/PTM decision is made by RNC2 for Cell 4, leading to an inefficient use of radio resources and of available bandwidth.

The solution according to an embodiment of this invention involves a so called “Iur-linking” procedure, which is initiated by the SRNC at a trigger event indicating that a mobile terminal in the URA_PCH state may be located in a cell that is not served by a Node B connected to the SRNC. The term Iur-linking is hereinafter defined as an information transfer between RNCs via the Iur-interface, and by the Iur-linking procedure according to this invention the SRNC transfers MBMS information stored as mobile terminal context information in the SRNC to potential DRNCs, thereby enabling the potential DRNCs to send an MBMS notification to the mobile terminal at session start of an MBMS service. The term “potential DRNC” is defined as all RNCs controlling at least one cell in the cell group (e.g. URA) in which said mobile terminal is located. The Iur-linking procedure according to this invention also enables the DRNC/CRNC to count a mobile terminal in the URA_PCH state when the mobile terminal is relocated to a cell served by a Node B connected to the DRNC/CRNC, wherein the counting result determines the choice of the PTP or the PTM scheme for the MBMS session start notification and for the multicasting of the MBMS data.

According to this invention, the transfer of information regarding multimedia service (e.g. MBMS)-joined mobile terminals via the Iur-interface (i.e. the Iur-linking procedure) is accomplished when the SRNC for a certain mobile terminal in a cell group location state (e.g. a URA_PCH state) sends a multimedia service attach requesting message (e.g. an MBMS ATTACH REQUEST) to all potential DRNCs, i.e. to all RNCs controlling at least one cell in the cell group (e.g. URA) in which said mobile terminal is located. The multimedia service attach requesting message preferably comprises information regarding the identity of the specific MBMS service which the mobile terminal has joined, the identity of the current URA in which the mobile terminal is located, the temporary identity of the mobile terminal in the radio network, and the identity of the mobile terminal. The potential DRNC receiving this MBMS attach requesting message will create and store a context for the mobile terminal, the context information comprising information included in the received MBMS attach requesting message. If no other MBMS-joined mobile terminal is located in any of the cells served by the Node Bs supervised by the DRNC/CRNC, the DRNC/CRNC will also create and store a context for the MBMS service, and indicate to the core network that is wants to receive future session start indications and MBMS user data regarding this particular MBMS service. This MBMS service context will comprise the identity of the MBMS service and the temporary identity of the mobile terminal in the radio network.

The Iur-linking procedure is performed at certain trigger events, which may be e.g. one of the following events:
1) The SRNC receives a URA updating message from the mobile terminal.
2) The mobile terminal transits into a URA_PCH state from any other state.
3) The SRNC receives an MBMS notification from the core network of start of an MBMS session.
4) The SRNC receives a Iu-link from the core network for a mobile terminal.

Thus, the Iur linking procedure will be triggered by e.g. one or more of these events in order to accomplish an efficient mobility handling of URA_PCH state mobile terminals.

Trigger events 1-3 are relevant when an MBMS service context for the mobile terminal already exist in the SRNC as a result of an Iu linking procedure performed between the core network (i.e. the SGSN) and the SRNC.

An additional trigger event may e.g. be when an MBMS service context for the mobile terminal is stored in the SRNC for the first time, i.e. the first time the mobile terminal transits from idle to connected mode.

However, at trigger event 4, the SRNC has no stored MBMS context for a mobile terminal in connected mode. This could happen e.g. when the user of a mobile terminal activates the MBMS a long time after the mobile terminal transited into connected mode, such that the mobile terminal may have transited e.g. into the URA_PCH state when the SRNC receives an Iu-link regarding the mobile terminal from the core network.

By means of the mobile terminal context stored in the potential DRNCs through the Iur linking procedure, the potential DRNCs will be able to send an MBMS session start notification to the mobile terminal in the URA_PCH state, and to count the mobile terminals for the PTM/PTP-decision in its role as a controlling RNC (CRNC).

An Iur linking procedure triggered by the event that the mobile terminal transits into a URA_PCH state (i.e. trigger event 2) may be referred to as an “early linking”, and an Iur linking procedure triggered by an MBMS notification from the core network (i.e. trigger event 3) may be referred to as a “late linking”.

An Iur linking procedure may also be triggered by the event that the URA_PCH mobile terminal relocates to a new URA and sends' an URA updating message to the SRNC (i.e. trigger event 1). Prior to the initiation of the Iur linking procedure, the SRNC will update its mobile terminal context information with the new URA location of the mobile terminal.

In case the new URA only comprises cells controlled by RNCs that are not controlling any cells in the previous URA, the SRNC will preferably transmit a multimedia service detach requesting message (e.g. an MBMS DETACH REQUEST) to the potential DRNCs of the previous URA. In case no other MBMS-joined mobile terminals remain in the previous URA, the SRNC may also delete the MBMS service context stored in the potential DRNCs.

At the start of an MBMS session, the radio network controller functioning as a controlling radio network controller (CRNC) will preferably count the MBMS-joined mobile terminals in each cell to be able to make a relevant PTM/PTP-decision. After an Iur-linking procedure regarding a certain mobile terminal in the URA_PCH state has been performed, the CRNC/DRNC will be able to count this mobile terminals as well, by means of the mobile terminal contexts stored in the potential DRNC at reception of the MBMS attach requesting message from the SRNC over the Iur interface, thereby achieving an improved PTM/PTP-decision.

When the number of mobile terminals in the URA_PCH state is low, this counting may e.g. be performed by means of the CRNC/DRNC paging each mobile terminal in the URA_PCH state individually, utilizing the stored mobile terminal contexts. When the mobile terminal receives such a paging, the mobile terminal responds with a cell updating message, indicating e.g. a special cause value or any existing cause value. The SRNC will receive this cell updating message from the CRNC/DRNC, and the SRNC will respond by transiting the mobile terminal back to the URA_PCH state. Alternatively, the paging message from CRNC/DRNC will include a special cause value informing the mobile terminal that the paging is performed only for counting purposes, and the SRNC will not receive the cell updating message. The mobile terminal will instead transit directly back to the URA_PCH state. Another alternative is that the mobile terminal transits directly back to the URA_PCH state, instead of sending a cell updating message to the SRNC.

When the number of mobile terminals in the URA_PCH state is higher, the counting may e.g. be performed by the CRNC/DRNC including a URA_PCH specific paging information in the MBMS notification message to be broadcasted on the MCCH. This paging information includes a probability factor, and by drawing a random number and using the received probability factor the mobile terminal may decide to transmit a Cell updating message to the CRNC/DRNC, with a specific MBMS cause value. The URA_PCH specific paging message may consist of the same paging message that is sent to the Idle mode mobile terminals. During this counting procedure, the mobile terminal remains in the URA_PCH state, and consequently the CRNC/DRNC will not forward the cell updating message to the SRNC. Instead, the counting procedure is terminated and no cell update confirming message is returned to the mobile terminal.

When the number of mobile terminals is high, thereby allowing statistical averaging over several cells, the counting may e.g. be performed by the CRNC/DRNC applying a homogeneous probability factor for the mobile terminals in each cell. If the URA comprises N cells, a URA_PCH mobile terminal can be counted as 1/N in each cell. The CRNC/DRNC may also take into account the cell location and the time of the last uplink message from the mobile terminal.

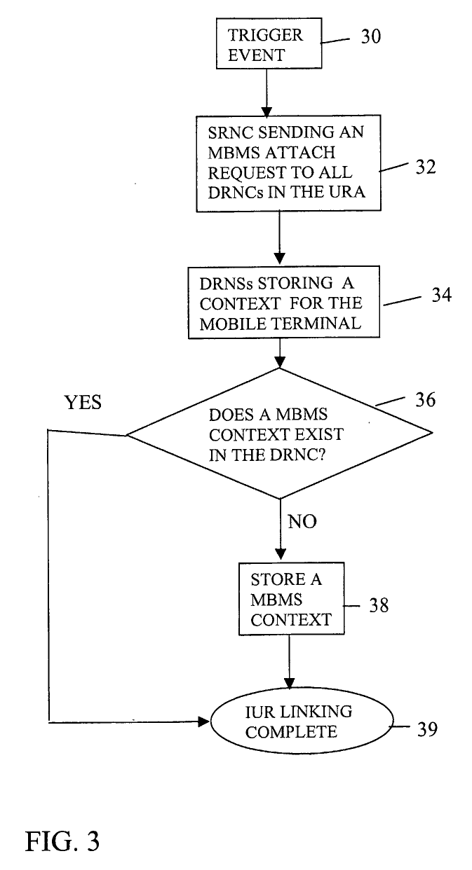

One embodiment of a Iur linking procedure according to the invention will now be described, with reference to the flow chart of FIG. 3.

The Iur linking procedure is triggered in step 30 by a trigger event being e.g. one of the events described above, for example by the SRNC receiving a URA updating message from a mobile terminal, by a mobile terminal transiting into a URA_PCH state from any other state, or by the SRNC receiving a notification from the core network of start of an MBMS session. In a next step 32, the SRNC initiates the Iur-linking procedure by sending an MBMS ATTACH REQUEST to all potential DRNCs located within the same URA as the SRNC. The MBMS ATTACH REQUEST comprises the ID (identity) of the joined MBMS service, the ID of the URA of the mobile terminal, the U_RNTI (the UMTS Radio Network Temporary Identity) of the mobile terminal, the IMSI (the International Mobile Station Identity) of the mobile terminal, and the UTRAN DRX Cycle Length. In step 34, the potential DRNCs have received the MBMS ATTACH MESSAGE and responds by creating and storing a new context for the mobile terminal, comprising information received from the SRNC. In a next step 36, it is determined whether the potential DRNC has any stored MBMS context, and if not, the potential DRNC will create and store a new MBMS service context in step 38, comprising information received from the SRNC. In step 39 the Iur linking procedure is completed.

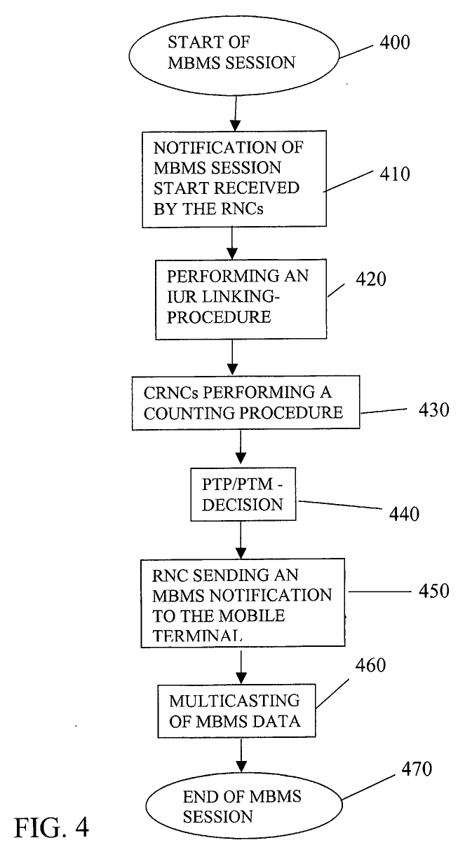

FIG. 4 shows a flow chart of one embodiment of an MBMS service session comprising the Iur linking procedure according to this invention. After the start of the MBMS session in step 400, the core network sends a notification of an MBMS session start to the RNCs via the Iu interface, which is received in step 410. Since this notification is a trigger event for the Iur linking procedure, the SRNCs will perform an Iur linking procedure in step 420, corresponding to steps 32-38 in FIG. 3. As a consequence of the Iur linking procedure, all RNCs being potential DRNCs will be able to send an MBMS notification to the mobile terminals in the URA_PCH state. However, before the MBMS notification, the DRNC/CRNC will make a PTM/PTM decision for each cell, and prior to this decision a counting of the MBMS-joined mobile terminals in each cell will be performed, the counting step including a counting procedure for the mobile terminals in the URA_PCH state as well, resulting in a more accurate decision. After completion of the counting in step 430, the CRNC will make the PTM/PTP decision in step 440, based on the counting result. Following the PTM/PTP decision, an MBMS notification is sent to the mobile terminals in the URA_PCH state in step 450, and MBMS data is multicasted by the PTM scheme or by the PTP scheme in step 460. The MBMS service session is completed in step 470.

According to one embodiment of the counting procedure of the mobile terminals in the URA_PCH state comprised in step 430, the counting is performed by means of the CRNC/DRNC paging each mobile terminal in the URA_PCH state individually, utilizing the stored mobile terminal contexts. When receiving the paging message, the mobile terminal will respond by sending a cell updating message indicating e.g. a special cause value or any existing cause value. The SRNC will then receive this cell updating message from the CRNC/DRNC, and the SRNC will respond by transiting the mobile terminal back to the URA_PCH state. Alternatively, the paging message from the CRNC/DRNC includes a special cause value informing the mobile terminal that the paging is performed only for counting purposes, and the SRNC will not receive the cell updating message; instead the mobile terminal will transit directly back to the URA_PCH state.

According to another embodiment of the counting procedure in step 430, counting of URA_PCH state mobile terminals is performed by the CRNC/DRNC including a URA_PCH specific paging information in the MBMS notification message to be broadcasted on the MCCH. This paging information includes a probability factor, and by drawing a random number and using the received probability factor the mobile terminal may decide to transmit a Cell updating message to the CRNC/DRNC, with a specific MBMS cause value. The URA_PCH specific paging message may consist of the same paging message that is sent to the Idle mode mobile terminals. During this counting procedure, the mobile terminal remains in the URA_PCH state, and consequently the CRNC/DRNC will not forward the cell updating message to the SRNC. Instead, the counting procedure is terminated and no cell update confirming message is returned to the mobile terminal.

According to still another embodiment of the counting procedure, which is suitable when the number of mobile terminals is high and allows statistical averaging over several cells, the counting is performed by the CRNC/DRNC applying a homogeneous probability factor for the mobile terminals in each cell. If the URA comprises N cells, a URA_PCH mobile terminal can be counted as 1/N in each cell. The CRNC/DRNC may also take into account the cell location and the time of the last uplink message from the mobile terminal.

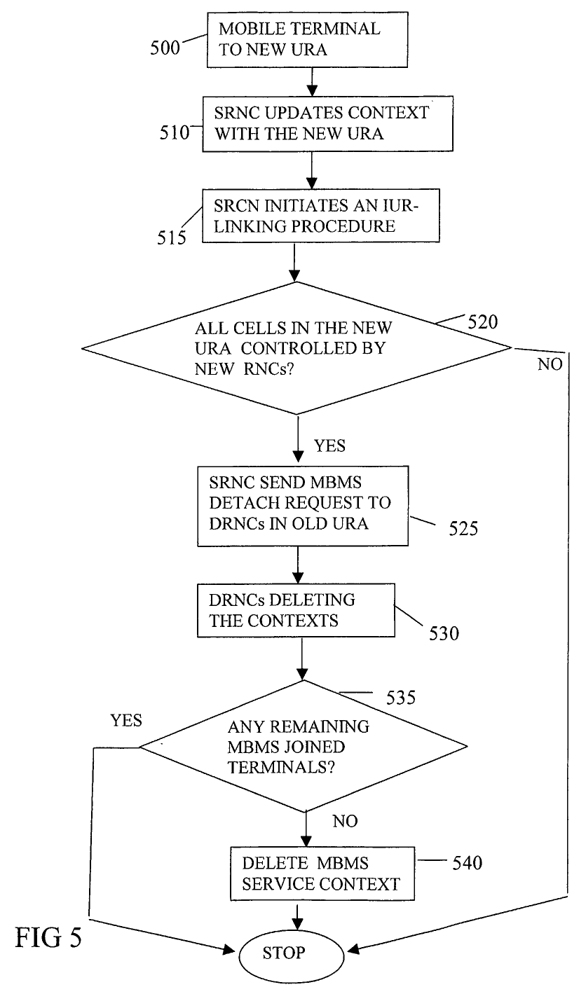

The flow chart of FIG. 5 discloses the steps performed when a mobile terminal in the URA_PCH state moves to a new URA, according to one embodiment of the invention, In 500, the URA_PCH mobile terminal relocates to a cell in a new URA and sends a URA UPDATE message to its SRNC. Upon receiving the URA UPDATE message, the SRNC will update its mobile terminal context with the new URA location in the next step, 510. Since the event in step 500 is a triggering event for the Iur linking procedure according to the invention, the SRNC will also initiate an Iur linking procedure, which is performed in step 515. In step 520, it is determined whether the new URA only comprises cells controlled by RNCs not controlling any cells in the previous URA. If so, the SRNC will in step 525 transmit an MBMS DETACH REQUEST to the potential DRNCs of the previous URA, followed by the DRNCs deleting the mobile terminal contexts in step 530. In step 535, it is determined whether any other MBMS-joined mobile terminals remain in the previous URA. If not, the SRNC will in step 540 initiate a deletion of the MBMS service context stored in the potential DRNCs.

The invention has been described with reference to specific exemplary embodiments and figures only to illustrate the inventive concept, and the invention is not limited to the disclosed embodiments. Instead, the invention is intended to cover various modification within the scope of the appended claims.

What is claimed is:

1.-33. (canceled)

34. A method in a radio access network of handling the mobility of a multimedia service joined mobile terminal in a cell group location state, in which state the location of the mobile terminal is stored at cell group level in a context of a radio network controller functioning as a serving radio network controller (SRNC) for the mobile terminal, comprising the steps of:
performing an information transfer at a first trigger event via an Iur-interface between a serving radio network controller (SRNC) and all radio network controllers controlling at least one cell in a first cell group and being potential drift radio network controllers (DRNCs) for the mobile terminal, wherein the information transfer step comprises the further steps of
sending, by the SRNC, a multimedia service attach requesting message to the potential DRNCs, the multimedia service attach requesting message comprising context information for the mobile terminal, the context information including multimedia service information; and
creating and storing, by the potential DRNCs, a context for the mobile terminal based on the received message.

35. The method according to claim 34, wherein the transferred context information comprises the identity of the joined multimedia service, the identity of the cell group, the temporary identity of the mobile terminal within the network, and the identity of the mobile terminal.

36. The method according to claim 34, wherein the SRNC and the potential DRNCs will send a multimedia session start notification based on the transferred context information when a multimedia session start notification is received from a core network.

37. The method according to claim 34, wherein the trigger event is the SRNC receiving a cell group updating message from the mobile terminal.

38. The method according to claim 37, further comprising the steps of:
sending a multimedia service detach requesting message from the SRNC to all potential DRNCs in the previous cell group, if the new cell group comprises only cells controlled by new RNCs; and
deleting, by the potential DRNCs in the previous cell group, the stored context of the mobile terminal.

39. The method according to claim 34, wherein the trigger event is the mobile terminal transiting into the cell group location state from any other state.

40. The method according to claim 34, wherein the trigger event is the SRNC receiving a notification from the core network of a start of a multimedia service session.

41. The method according to claim 34, wherein each of the potential DRNCs create and store a multimedia service context in case no other multimedia service joined mobile terminal is located in the cells controlled by each potential DRNC.

42. The method according to claim 34, wherein the multimedia service context comprises the identity of the multimedia service and the temporary identity of the mobile terminal within the radio access network.

43. The method according to claim 34, further comprising the step of performing a counting procedure for each cell before a PTM/PTP decision by radio network controllers functioning as Controlling Radio Network Controllers (CRNCs).

44. The method according to claim 43, wherein the counting procedure step is performed by paging each mobile terminal in the cell group location state individually by means of the stored context information.

45. The method according to claim 43, wherein the counting procedure step is performed by including a cell group location specific paging information comprising a probability factor in a broadcasted multimedia service session start notification.

46. The method according to claim 43, wherein the counting procedure step is performed by estimating a probability factor for the mobile terminals of each cell.

47. The method according to claim 34, wherein the first cell group consists of a UTRAN Registration Area (URA) according to the 3GPP standard.

48. The method according to claim 34, wherein the cell group location state is a URA_PCH state according to the 3GPP standard.

49. The method according to claim 34, wherein the multimedia service is a Multimedia Broadcasting/Multicasting Service (MBMS), according to the 3GPP standard.

50. The method according to claim 34, wherein the multimedia service attach requesting message is an MBMS ATTACH REQUEST, according to the 3GPP standard.

51. A radio network controller in a radio access network functioning as a serving radio network controller (SRNC) for a multimedia service joined mobile terminal in a cell group location state and provided with stored context information for the mobile terminal, the serving radio network controller being arranged to communicate with other radio network controllers via an Iur interface, comprising a means adapted to perform an information transfer of a multimedia service attach requesting message comprising the context information at a trigger event to all other radio network controller controlling at least one cell within the cell group of the mobile terminal and being potential drift radio network controllers (DRNCs) for the mobile terminal.

52. The radio network controller according to claim 51, wherein the context information comprises the identity of the joined multimedia service, the identity of the cell group, the temporary identity of the mobile terminal within the network, and the identity of the mobile terminal.

53. The radio network controller according to claim 51, further comprising means adapted to send a multimedia session detach requesting message to all potential DRNCs in the previous cell group upon receiving a cell group updating message from the mobile terminal and the new cell group only consist of cells controlled by new RNCs.

54. The radio network controller according to claim 51 having a means for functioning as a controlling radio network controller (CRNC), further comprising a means adapted to perform a counting procedure before making a PTP/PTM decision for a cell.

55. The radio network controller according to claim 54, further comprising a means adapted to perform the counting procedure by paging each mobile terminal in the cell group location state individually by means of the stored context information.

56. The radio network controller according to claim 54, wherein the means adapted to perform the counting procedure by including a cell group location specific paging information further comprises a probability factor in a broadcasted multimedia service session start notification.

57. The radio network controller according to claim 54, wherein the means for performing the counting procedure is adapted to estimate a probability factor for the mobile terminals of each cell.

58. The radio network controller according to claim 54, wherein the first cell group consists of a UTRAN Registration Area (URA) according to the 3GPP standard.

59. The radio network controller according to claim 51, wherein the cell group location state is a URA_PCH state according to the 3GPP standard.

60. The radio network controller according to claim 51, wherein the multimedia service is a Multimedia Broadcasting/Multicasting Service (MBMS), according to the 3GPP standard.

61. The radio network controller according to claim 51, wherein the multimedia service attach requesting message is an MBMS ATTACH REQUEST, according to the 3GPP standard.

62. A radio network controller in a radio access network being a potential drift radio network controller (DRNC) for a multimedia service joined mobile terminal in a cell group location state, the radio network controller arranged to communicate with other radio network controllers via an Iur interface, comprising:
means adapted to receive an information transfer of a multimedia service attach requesting message comprising context information for a mobile terminal from a radio network controller functioning as a serving radio network controller (SRNC) adapted to perform an information transfer of a multimedia service attach requesting message comprising the context information at a trigger event to all other radio network controllers controlling at least one cell within the cell group of the mobile terminal and being potential drift radio network controllers (DRNCs) for the mobile terminal: and
means adapted to create and store context information for the mobile terminal using the received message.

63. The radio network controller according to claim 62, wherein the context information comprises the identity of the joined multimedia service, the identity of the cell group, the temporary identity of the mobile terminal within the network, and the identity of the mobile terminal.

64. The radio network controller according to claim 62, wherein the means adapted to send a multimedia service session start notification to the mobile terminal based on the stored context information when a multimedia session start notification is received from a core network.

65. The radio network controller according to claim 62, wherein the means adapted to create and store a multimedia service context in case no other multimedia service joined mobile terminal, is located in the cells controlled by the radio network controller.

66. The radio network controller according to claim 65, wherein the multimedia service context comprises the identity of the multimedia service and the temporary identity of the mobile terminal within the radio network.
